(19) United States
(12) Patent Application Publication
(10) Pub. No.: US 2019/0034613 A1
(43) Pub. Date: Jan. 31, 2019

(54) ONE TIME GRAPHICAL PATTERN AUTHENTICATION

(71) Applicant: CA, INC., New York, NY (US)

(72) Inventors: Udaykumar Gopal JAJOO, Hyderabad (IN); Dhiraj GIRDHAR, Westborough, MA (US); Yogesh Ashok JOSHI, Hyderabad (IN); Puneet Kumar DAWER, Hyderabad (IN)

(73) Assignee: CA, Inc.

(21) Appl. No.: 15/661,646

(22) Filed: Jul. 27, 2017

(51) Int. Cl. G06F 21/36; H04L 29/06

(52) U.S. Cl. CPC G06F 21/36; H04L 63/083; H04L 2463/082; H04L 63/0838; H04L 63/0884

(57) ABSTRACT

A method includes receiving, from a user, a request to authenticate. The authentication request may include a user id. The method may also include verifying the user id. The method also includes generating a request for a one-time graphical pattern. The method further includes transmitting the request for the one-time graphical pattern to a server and receiving, from the server, the one-time graphical pattern. The method includes transmitting the one-time graphical pattern to the user and prompting the user to input the graphical pattern. The method may also include receiving the inputted graphical pattern from the user and determining whether the inputted graphical pattern matches the transmitted one-time graphical pattern sent to the user. If the inputted graphical pattern matches the transmitted one-time graphical pattern sent to the user, the method may include authenticating the user.

### BACKGROUND

The disclosure relates generally to authentication, and more specifically to one-time graphical pattern authentication.

### SUMMARY

According to one embodiment of the disclosure, a method includes receiving, from a user, a request to authenticate. The authentication request may include a user id. The method may also include verifying the user id. The method also includes generating a request for a one-time graphical pattern. The method further includes transmitting the request for the one-time graphical pattern to a server and receiving, from the server, the one-time graphical pattern. The method includes transmitting the one-time graphical pattern to the user and prompting the user to input the graphical pattern. The method may also include receiving the inputted graphical pattern from the user and determining whether the inputted graphical pattern matches the transmitted one-time graphical pattern sent to the user. If the inputted graphical pattern matches the transmitted one-time graphical pattern sent to the user, the method may include authenticating the user.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a system for provisioning and using one-time graphical pattern authentication in accordance with a non-limiting embodiment of the present disclosure.

FIG. 2 illustrates a flow diagram of a method for provisioning and using a one-time graphical pattern authentication in accordance with a non-limiting embodiment of the present disclosure.

FIG. 3 illustrates a flow diagram of a method for provisioning and using a one-time graphical pattern authentication in accordance with a non-limiting embodiment of the present disclosure.

FIG. 4 illustrates an example of a provisioned grid for a one-time graphical pattern authentication in accordance with a non-limiting embodiment of the present disclosure.

FIG. 5 illustrates an example of a provisioned grid for a one-time graphical pattern authentication in accordance with a non-limiting embodiment of the present disclosure.

FIG. 6 illustrates an example of a provisioned grid for a one-time graphical pattern authentication in accordance with a non-limiting embodiment of the present disclosure.

FIG. 7 illustrates an example of a provisioned grid for a one-time graphical pattern authentication in accordance with a non-limiting embodiment of the present disclosure.

FIG. 8 illustrates a flow chart of a method for provisioning and using a one-time graphical pattern authentication in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Authentication is the process by which a user provides credentials to a system and the system verifies that those credentials allow the user to access the system. Single-factor authentication identifies the user requesting access with just one set of credentials, for example a username and password. Two-factor authentication identifies the user requesting access with two different sets of credentials, for example (i) a username and password and (ii) a code that is sent to the user's mobile phone or email address. Certain security systems use CAPTCHAS (an acronym for “Completely Automated Public Turing test to tell Computers and Humans Apart”) in challenge-response form that allows the computer to tell whether the user is human.

Touch screens present certain difficulties for users. For example, it may be significantly easier for a user to swipe a screen than to type on a touch screen. As another example, usernames and passwords may be susceptible to shoulder surfing, or the practice of another party spying (for example, over the user's shoulder) on what the user is typing on their keyboard or electronic device in order to obtain the user's personal access information.

An embodiment of the present invention allows users to draw a one-time graphical pattern on their device, which may add significant benefit in a touch-screen environment. Drawing a pattern is easier for the user and more convenient, and the user need not memorize a sequence of characters or pattern. It avoids the insecure practice of having a user use the same username and password for multiple purposes or choosing a simple password because it is easy to remember. Because the pattern is a one-time pattern, it is more secure. Drawing a graphical pattern also avoids the danger of shoulder surfing. Pattern length can also be configured during runtime on the server side.

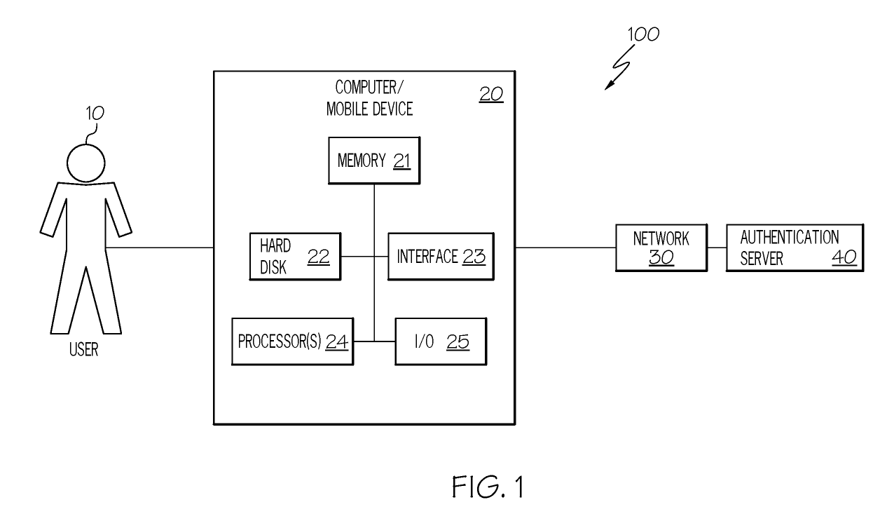

With reference to FIG. 1, a system 100 for provisioning and using one-time graphical pattern authentication in accordance with a non-limiting embodiment of the present disclosure, user 10 uses computer or mobile device 20. Computer or mobile device 20 can be any type of computer or computing device that user may need to log into, including but not limited to a desktop, laptop, or hand-held computer, a tablet, a digital camera or video camera, a gaming system, a scanner or scanning device, or any type of mobile device, including but not limited to a mobile phone. Computer or mobile device 20 also includes any device that has a touch screen. Computer or mobile device 20 may include memory 21, which may be any type of temporary or permanent storage, including but not limited to flash memory, a removable drive, RAM, ROM, or any other type of memory or storage. Computer or mobile device 20 may include a hard disk 22, an interface 23, one or more processors 24, and input/output (I/O) 25. The computer or mobile device 20 is connected to network 30, which may be any type or network, including the cellular network or the Internet, through a wired or wireless connection. Computer or mobile device 20 communicates with authentication server 40 over network 30. Authentication 30 may be any type of server program or physical server device that performs authentication.

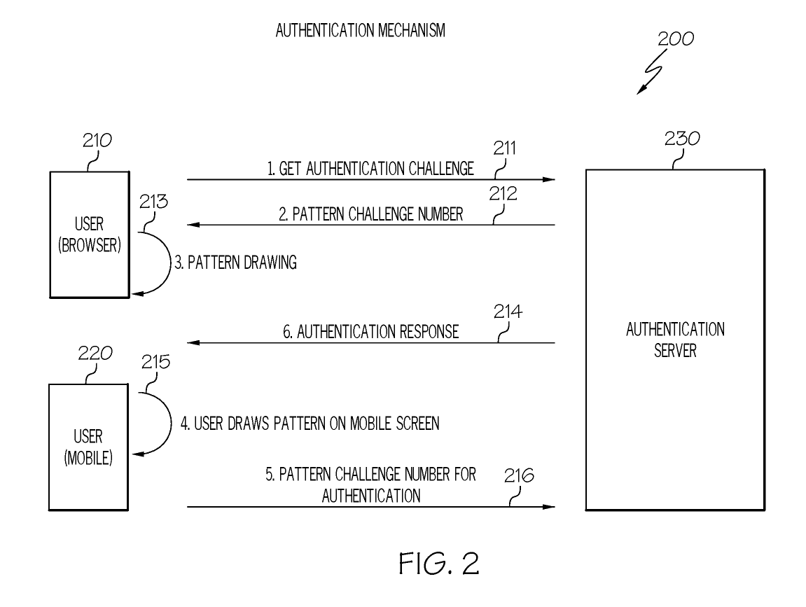

With reference to FIG. 2, a flow diagram 200 of a method for provisioning and using a one-time graphical pattern authentication in accordance with a non-limiting embodiment of the present disclosure, a user may access the authentication mechanism through, for example, a browser 210 or through a mobile device 220. However, a user may authentication through any other interface, whether it be on a computer or a mobile device 20. At 211, the user gets the authentication challenge from authentication server 230. At 212, the user receives the pattern challenge number. At 213, the user draws the pattern on its screen. Alternatively, the user can use mobile device 220 to draw the pattern on the mobile screen at 215. The pattern challenge number is sent to authentication server 230 for authentication at 216. At 214, authentication server 230 sends the authentication response to the user.

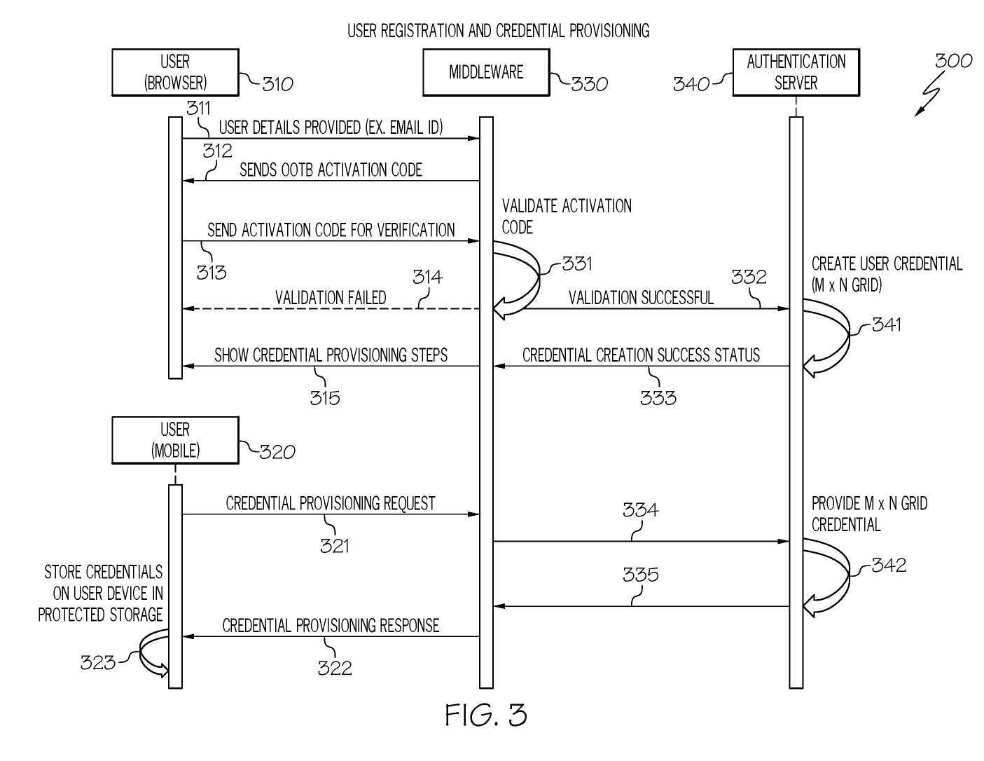

With reference to FIG. 3, a flow diagram 300 of a method for provisioning and using a one-time graphical pattern authentication in accordance with a non-limiting embodiment of the present disclosure, more detail is shown for user registration and credential provisioning. As discussed previously, the user may use any device to authenticate, but examples of a browser 310 and a mobile device 320 are given in this example. The user communicates through browser 310 or mobile device 320 to middleware 330, which communicates with authentication server 340.

At 311, the user details are provided to middleware 330 by the user through browser 310. For example, the user's username or email address may be provided. A password may also be provided. The following steps can be performed with or without middleware. In an embodiment of the present disclosure, middleware is used. Middleware 330 sends the user an activation code at 312. The activation code may be, for example, out of the box (OOTB). At 313, the user sends the activation code for verification (for example, for two-factor authentication). Middleware 330 validates the activation code at 331. If the validation fails at 314, then access will be denied and the user may be prompted again to enter an appropriate authentication code. If validation is successful at 332, then authentication server 340 may create a user credential at 341. The user credential may take the form of a grid of any size, for example M×N. M and N may represent any number, including the same number. The user credential may also take a less structured form or a form that is not grid-like in appearance. For example, the user credential may be circular in nature or free-flowing in any shape or form. For simplicity, “grid” will be used from here forward to include all shapes and forms discussed above. Once the grid is created, at 333, authentication server 340 may transmit a credential creation success status to middleware 330, which may, in response, show the credential provisioning steps to the user at 315. The process described above may be known as user registration. A user typically must register the first time it uses the system, but need not register each time it uses the system. In certain embodiments, it may be useful for the user to perform one or more steps associated with registration more than once or every time it uses the system.

At 321, the user, for example through mobile device 320, creates a credential provisioning request and transmits the request to middleware 330. At 334, that credential provisioning request is sent by middleware 330 to authentication server 340. At 342, authentication server 340 provides the user credential, for example an M×N grid user credential and transmits the credential at 335 to middleware 330. Middleware 330 transmits a credential provisioning response at 322 to the user. At 323, the user may store credentials on their device in storage, for example protected storage. For example, the credential may be protected using any encryption algorithm, such as public key infrastructure (PKI) or a user factor.

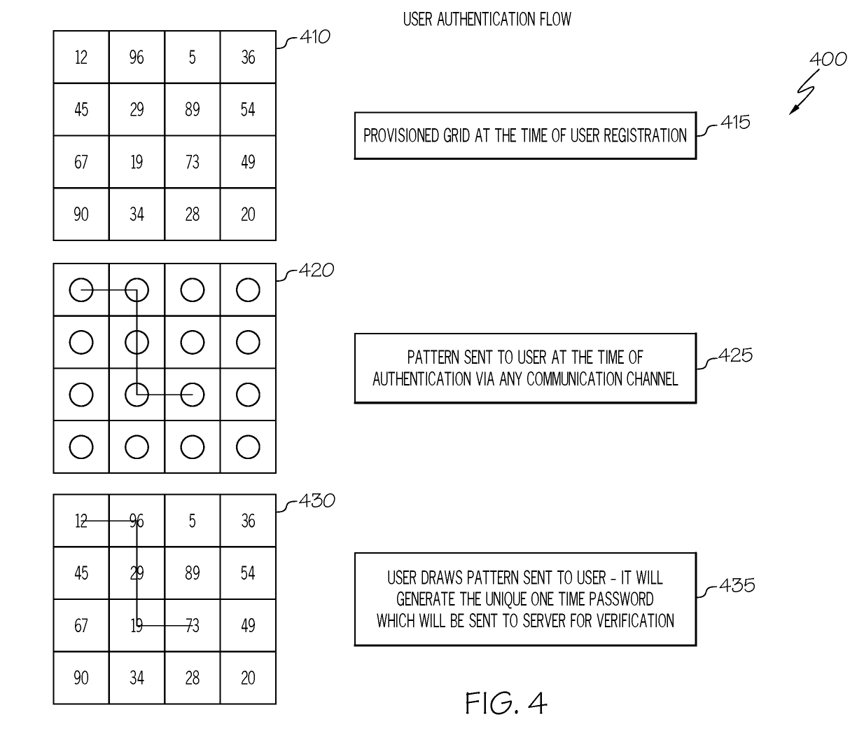

With reference to FIG. 4, an example of a provisioned grid 400 for a one-time graphical pattern authentication in accordance with a non-limiting embodiment of the present disclosure, a user authentication flow is shown. An example 4×4 grid 410 is shown, but as explained above this pattern may be in any shape or form and may take any size. Grid 410 is comprised of a number corresponding to each slot. These numbers may be selected randomly or with intention. Numbers may be repeated. At 415, the grid is provisioned at the time of user registration. The same grid may be associated with the user for life, or a new grid may be provisioned for the user at any interval. A new grid may be provisioned after every use, for example, or a new grid may be provisioned after set intervals after the grid expires. At 425, a pattern is sent to the user at the time of authentication via any communication channel. 420 is an example of a pattern that may be sent to the user, but the pattern may be of any shape or length. In the example of 420, the pattern is five squares long and bends in two places. The user receives the pattern and at 435, the user draws the pattern that it was sent. In drawing the pattern, a unique one-time password will be created. The unique one-time password may include a combination of numbers, images, and characters. The unique one-time password generated from the one-time pattern and the grid is then sent to the authentication server for verification. 430 is an example of the user drawing the pattern on his or her own unique grid. The pattern corresponds to certain numbers in the underlying grid, and those numbers form the one-time password. Any algorithm, including a randomizing algorithm, may be used to form this password from these numbers.

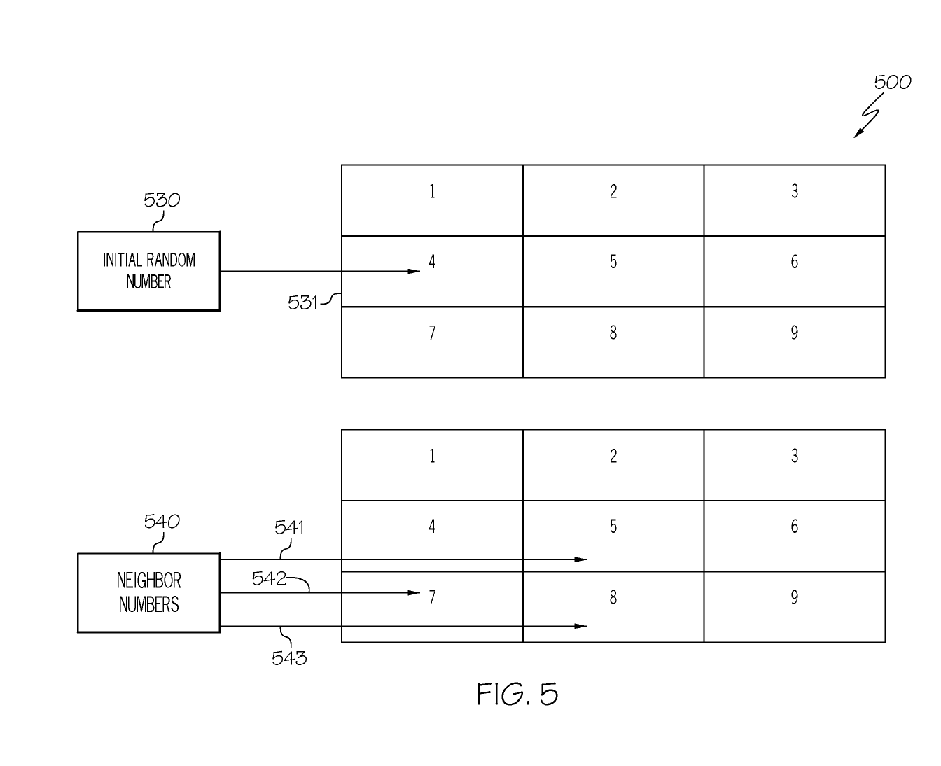

Any algorithm, including a randomizing algorithm, may be used to generate the pattern sent to the user. For example, with reference to FIG. 5, an example of a provisioned grid 500 for a one-time graphical pattern authentication in accordance with a non-limiting embodiment of the present disclosure is shown. In this example, the pattern that is generated and sent to the user is created using the nearest neighbor algorithm. In the nearest neighbor algorithm, which can be used to solve the traveling salesman problem, the salesman starts at a random city and repeatedly visits the nearest city until all cities have been visited. A description with respect to the present embodiment of the present disclosure is shown in FIG. 5. An example grid is shown for illustrating purposes and filled with numbers 1 through 9. Initial random number 530 is chosen through any method, whether it be truly random or semi-random. The number may also be chosen non-randomly. In this example, the far-left middle grid position 531 is selected, which is 4. The algorithm then chooses neighboring numbers 540 until the pattern is complete. For example, the algorithm takes the right-neighboring number of 5 at 541, then the bottom-neighboring number of 8 at 543, then the left-neighboring number of 7 at 542. In the end, the pattern goes from cell to cell from 4 to 5 to 8 to 7. The pattern is then sent to the user, and the unique password is generated from the underlying numbers when the user draws the pattern on his or her grid.

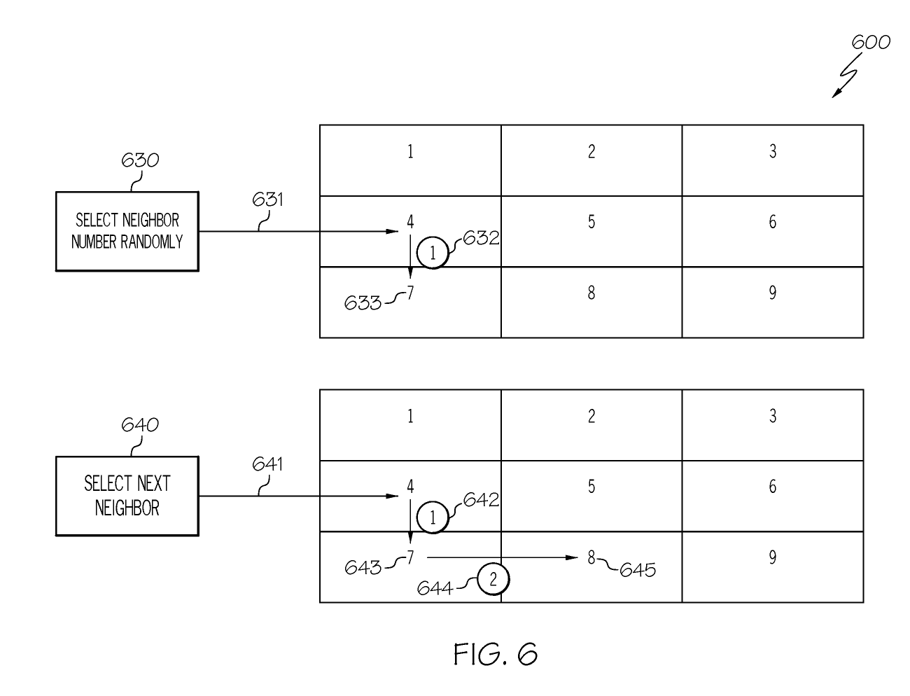

In another example, with reference to FIG. 6, an example of a provisioned grid 600 for a one-time graphical pattern authentication in accordance with a non-limiting embodiment of the present disclosure is shown. An example grid is shown for illustrating purposes and filled with numbers 1 through 9. Initial random number 630 is chosen through any method at 631, whether it be truly random or semi-random. The number may also be chosen non-randomly. In this example, the far-left middle grid position is selected at 632, which is 4. The algorithm then chooses neighboring numbers 640 until the pattern is complete. For example, the algorithm takes the bottom-neighboring number of 7 at 633, then the right-neighboring number of 8 at 6452. In the end, the pattern goes from cell to cell from 4 to 7 to 8. The pattern is then sent to the user, and the unique password is generated from the underlying numbers when the user draws the pattern on his or her grid.

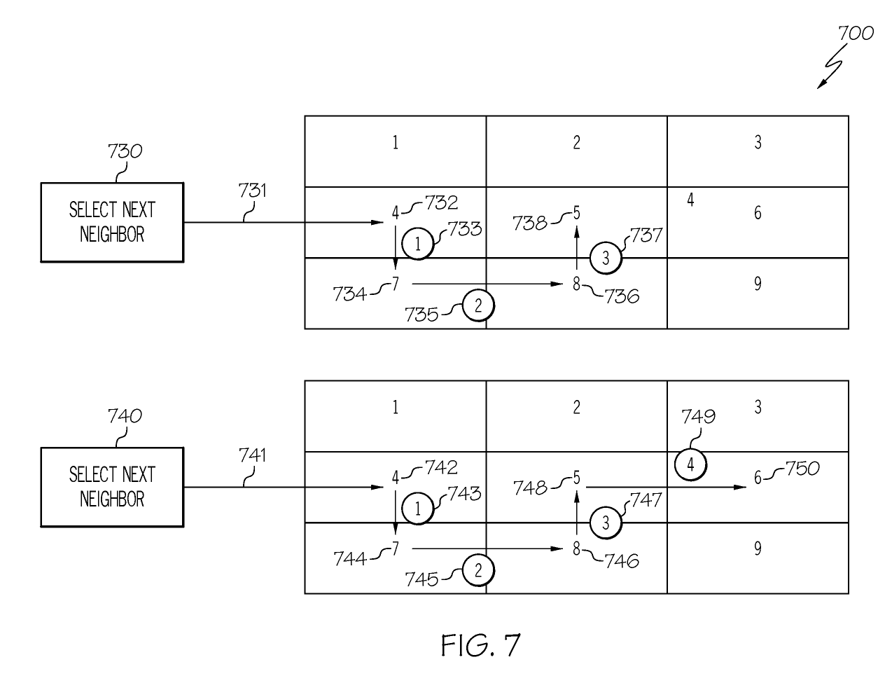

In another example, with reference to FIG. 7, an example of a provisioned grid 700 for a one-time graphical pattern authentication in accordance with a non-limiting embodiment of the present disclosure is shown. In this example, the algorithm continues from the previous example to form a longer pattern. At 737, the top-neighbor, which is 5, is chosen. At 749, the right-neighbor, which is 6, is chosen. This can continue indefinitely until the desired length is attained. A pattern may also be a dot, or just one number.

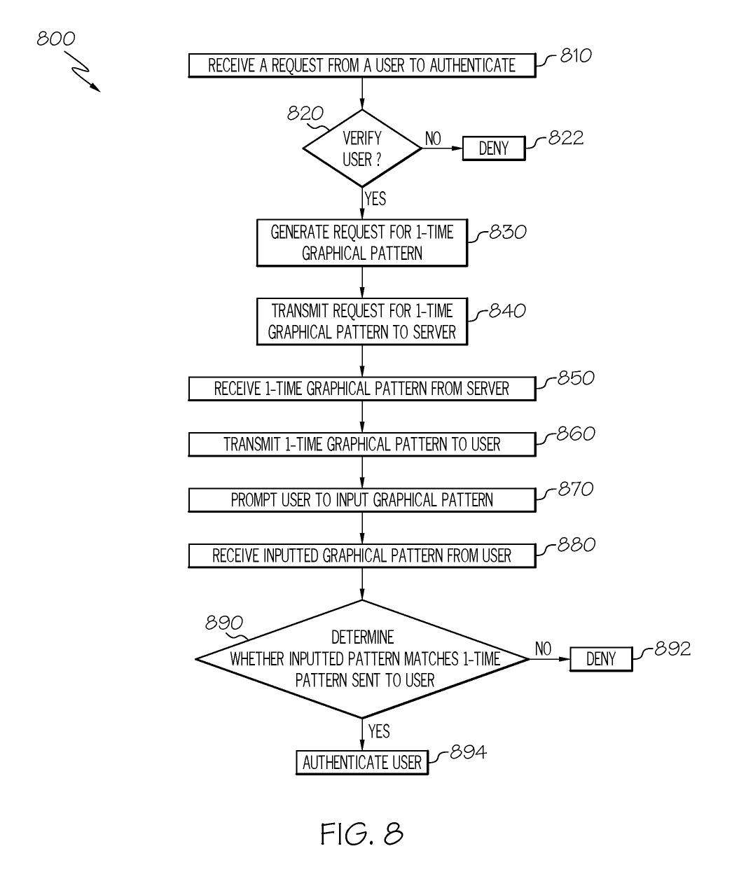

With reference to FIG. 8, a flow chart 800 of a method for provisioning and using a one-time graphical pattern authentication in accordance with a non-limiting embodiment of the present disclosure is shown. At 810, the method comprises receiving from a user a request to authenticate. The authentication request may include a user id, a username, an email address, a password, and/or additional information. At 820, the method comprises verifying the user id or other identification information provided in the previous step. If the user is not verified, then at 822 the user is denied. The user may be re-prompted for their identifying information or locked out of the system. If the user is verified, then at 830, the method generates, using the processor, a request for a one-time graphical pattern. At 840, the method transmits the request for the one-time graphical pattern to a server, for example the authentication server. At 850, the method receives the one-time graphical pattern from the server. At 860, the method transmits the one-time graphical pattern to the user. At 870, the method prompts the user to input the graphical pattern. At 880, the method receives the inputted graphical pattern from the user. At 890, the method determines whether the inputted graphical pattern matches the transmitted one-time graphical pattern sent to the user. If the two patterns do not match, the user is denied at 892 and may be asked to re-input the pattern or may be locked out of the system. If the two patterns do match, then at 894 the method authenticates the user.

The method may further comprise determining that the user is a first-time user. In this instance, the method may prompt the user to register. In response to determining that the user is a first-time user, the method may transmit an activation code to the user. The method may prompt the user to input the activation code through one of many methods, for example typing. The method may also receive the authentication code from the user. The method may, in response to receiving the authentication code from the user, validate the authentication code. The user registration may be saved on the authentication server or other platform so that when the user authenticates the next time, the user may not be prompted to register again.

The method may further comprise, in response to receiving the authentication code from the user, requesting a grid from the server and receiving the grid from the server. The grid may be unique to the user. In alternate embodiments, the grid may not be unique to the user, but the password derived from the pattern and the grid may be unique to the user. The method may also comprise generating a unique one-time password from the inputted graphical pattern and the grid. The method may also include using the unique one-time password to authenticate the user.

The method may deny a user if its identification is not verified. For example, the method may include receiving from a second user a second request to authenticate, the second authentication request comprising a second user id. If the second user id is not verified, the method may include formatting for display to the second user a denial message. In another example, the method may include receiving from a second user a second request to authenticate, the second authentication request comprising a second user id or other identification. The method may comprise verifying the second user id or other identification, generating a second question for a second one-time graphical pattern using the processor, and transmitting the second request for the second one-time graphical pattern to the server. The method may comprise receiving, from the server, the second one-time graphical pattern, transmitting the second one-time graphical pattern to the second user, and prompting the second user to input the second graphical pattern. The method may further comprise receiving the inputted second graphical pattern from the second user and determining whether the inputted second graphical pattern matches the transmitted second one-time graphical pattern sent to the user. If the patterns do match, the second user may be authenticated. If the inputted second graphical pattern does not match the transmitted second one-time graphical pattern sent to the user, the method may include formatting for display to the second user a denial message.

The method may comprise deleting the one-time graphical pattern after the user is authenticated. The length of the one-time graphical pattern may vary between users or may be the same length for every user. The graphical pattern may be inputted by a user via a touch screen, conventional keyboard or mouse, or any other input device. The graphical pattern may take any form or shape, including but not limited to a line, curved or straight, square, rectangle, rhombus, circle, bubble, polygon, or combination of images.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving, from a user, a request to authenticate, the authentication request comprising a user id;
verifying the user id;
generating, using a processor, a request for a one-time graphical pattern;
transmitting the request for the one-time graphical pattern to a server;
receiving, from the server, the one-time graphical pattern;
transmitting the one-time graphical pattern to the user;
prompting the user to input the graphical pattern;
receiving the inputted graphical pattern from the user;
determining whether the inputted graphical pattern matches the transmitted one-time graphical pattern sent to the user; and
if the inputted graphical pattern matches the transmitted one-time graphical pattern sent to the user, authenticating the user.

2. The method of claim 1, further comprising:
determining that the user is a first-time user;
in response to determining that the user is a first-time user:
transmitting an activation code to the user;
prompting the user to input the authentication code;
receiving the authentication code from the user; and
in response to receiving the authentication code from the user, validating the authentication code.

3. The method of claim 2, further comprising, in response to receiving the authentication code from the user:
requesting a grid from the server; and
receiving, from the server, the grid.

4. The method of claim 3, further comprising:
generating a unique one-time password from the inputted graphical pattern and the grid; and
using the unique one-time password to authenticate the user.

5. The method of claim 1, further comprising:
receiving from a second user a second request to authenticate, the second authentication request comprising a second user id; and
if the second user id is not verified, formatting for display to the second user a denial message.

6. The method of claim 1, further comprising:
receiving from a second user a second request to authenticate, the second authentication request comprising a second user id;
verifying the second user id;
generating, using the processor, a second request for a second one-time graphical pattern;
transmitting the second request for the second one-time graphical pattern to the server;
receiving, from the server, the second one-time graphical pattern;
transmitting the second one-time graphical pattern to the second user;
prompting the second user to input the second graphical pattern;
receiving the inputted second graphical pattern from the second user;
determining whether the inputted second graphical pattern matches the transmitted second one-time graphical pattern sent to the user; and
if the inputted second graphical pattern does not match the transmitted second one-time graphical pattern sent to the second user, formatting for display to the second user a denial message.

7. The method of claim 1, further comprising deleting the one-time graphical pattern after the user is authenticated.

8. The method of claim 1, wherein the length of the one-time graphical pattern varies between users.

9. The method of claim 1, wherein the inputted graphical pattern is inputted by the user by drawing on a touch screen.

10. The method of claim 1, wherein the transmitted one-time graphical pattern is a circle.

11. A computer configured to access a storage device, the computer comprising:
a processor; and
a non-transitory, computer-readable storage medium storing computer-readable instructions that when executed by the processor cause the computer to perform:
in response to receiving, from a user, a request to authenticate, verifying the user id,
wherein the authentication request comprises a user id;
generating, using the processor, a request for a one-time graphical pattern;
transmitting the request for the one-time graphical pattern to a server;
in response to receiving, from the server, the one-time graphical pattern, transmitting the one-time graphical pattern to the user;
prompting the user to input the graphical pattern;
in response to receiving the inputted graphical pattern from the user, determining whether the inputted graphical pattern matches the transmitted one-time graphical pattern sent to the user; and
if the inputted graphical pattern matches the transmitted one-time graphical pattern sent to the user:
generating a unique one-time password from the inputted graphical pattern and a grid; and
using the unique one-time password to authenticate the user.

12. The computer of claim 11, wherein the computer-readable instructions further cause the computer to perform, in response to receiving the authentication code from the user:
requesting a grid from the server; and
receiving, from the server, the grid.

13. The computer of claim 12, wherein the computer-readable instructions further cause the computer to perform:
generating a unique one-time password from the inputted graphical pattern and the grid; and
using the unique one-time password to authenticate the user.

14. The computer of claim 11, wherein the computer-readable instructions further cause the computer to perform:
receiving from a second user a second request to authenticate, the second authentication request comprising a second user id; and
if the second user id is not verified, formatting for display to the second user a denial message.

15. The computer of claim 11, wherein the computer-readable instructions further cause the computer to perform:
receiving from a second user a second request to authenticate, the second authentication request comprising a second user id;
verifying the second user id;
generating, using the processor, a second request for a second one-time graphical pattern;
transmitting the second request for the second one-time graphical pattern to the server;
receiving, from the server, the second one-time graphical pattern;
transmitting the second one-time graphical pattern to the second user;
prompting the second user to input the second graphical pattern;
receiving the inputted second graphical pattern from the second user;
determining whether the inputted second graphical pattern matches the transmitted second one-time graphical pattern sent to the user; and
if the inputted second graphical pattern does not match the transmitted second one-time graphical pattern sent to the second user, formatting for display to the second user a denial message.

16. The computer of claim 11, wherein the computer-readable instructions further cause the computer to perform deleting the one-time graphical pattern after the user is authenticated.

17. The computer of claim 11, wherein the length of the one-time graphical pattern varies between users.

18. The computer of claim 11, wherein the inputted graphical pattern is inputted by the user by drawing on a touch screen.

19. The computer of claim 11, wherein the transmitted one-time graphical pattern is a circle.

20. A non-transitory computer-readable storage medium storing instructions that are executable to cause a system to perform operations comprising:
in response to receiving, from a user, a request to authenticate, verifying the user id,
wherein the authentication request comprises a user id;
generating, using a processor, a request for a one-time graphical pattern;
transmitting the request for the one-time graphical pattern to a server;
in response to receiving, from the server, the one-time graphical pattern, transmitting the one-time graphical pattern to the user;
prompting the user to input the graphical pattern;
in response to receiving the inputted graphical pattern from the user, determining whether the inputted graphical pattern matches the transmitted one-time graphical pattern sent to the user; and
requesting a grid from the server;
receiving, from the server, the grid;
if the inputted graphical pattern matches the transmitted one-time graphical pattern sent to the user:
generating a unique one-time password from the inputted graphical pattern and the grid; and
using the unique one-time password to authenticate the user.
